(19) United States
(12) Patent Application Publication
(10) Pub. No.: US 2008/0158224 A1
(43) Pub. Date: Jul. 3, 2008

(54) METHOD FOR GENERATING AN ANIMATABLE THREE-DIMENSIONAL CHARACTER WITH A SKIN SURFACE AND AN INTERNAL SKELETON

(75) Inventors: Hong-Ren WONG, Kaohsiung City (TW); Jun-Ming Lu, Jhongli City (TW); Mao-Jun Wang, Hsinchu (TW)

Correspondence Address: EGBERT LAW OFFICES, 412 MAIN STREET, 7TH FLOOR, HOUSTON, TX, 77002, US

(73) Assignee: NATIONAL TSING HUA UNIVERSITY, Hsinchu (TW)

(21) Appl. No.: 11/617,600

(22) Filed: Dec. 28, 2006

(51) Int. Cl. G06T 15/00; G06T 15/70

(52) U.S. Cl. 345/419; 345/473

(57) ABSTRACT

The present invention is an animatable 3D character with a skin surface and an internal skeleton and a production method thereof. 3D scanned data is used to generate an animatable 3D character, formed of a skin surface and an internal skeleton. The method includes using scanned data to generate a skin surface, generating the internal skeleton, and linking the skin surface with the internal skeleton and establishing an animation mechanism. The complete skin surface can be generated in a sequence from points to lines and then from lines to a surface based on the interrelation therebetween. Landmark extraction methods identify major body joints and end points of body segments that may influence motions. And these points are connected to form the internal skeleton. The skin surface is linked to the internal skeleton, so that while controlling the internal skeleton, the skin surface can be driven to generate motion.

### CROSS-REFERENCE TO RELATED U.S. APPLICATIONS

Not applicable.

### STATEMENT REGARDING FEDERALLY SPONSORED RESEARCH OR DEVELOPMENT

Not applicable.

### NAMES OF PARTIES TO A JOINT RESEARCH AGREEMENT

Not applicable.

### REFERENCE TO AN APPENDIX SUBMITTED ON COMPACT DISC

Not applicable.

### BACKGROUND OF THE INVENTION

1. Field of the Invention

The present invention relates generally to a three-dimensional (3D) character and a production method thereof, and more particularly to an innovative animatable 3D character with a skin surface and an internal skeleton.

2. Description of Related Art Including Information Disclosed Under 37 CFR 1.97 and 37 CFR 1.98

With the advancement of computer graphics and information technology, animation and simulation become more and more important in the industry, and the demand for digital human models rises.

The digital human model is usually composed of static attributes (e.g. anthropometric information, appearance) and dynamic attributes (e.g. biomechanical model, physiological model). But related research and technologies often focus on only one of these two categories. A digital human model with both the static and dynamic attributes is rarely seen.

In the development of static attributes of the digital human model, anthropometric information, such as body height or other dimensions was used to represent the attributes. In this way, evaluations can be made by using very simple geometry. However, this kind of model produces lower similarity to the real human. In order to make it more real, the 3D scanner has been widely used for modeling. Some related studies built models by establishing triangular meshes directly based on the relationship between data points, while others used key landmarks as control points to generate smooth surfaces. Nevertheless, no matter which method is used, the produced model is static and not animatable.

In the development of dynamic attributes of the digital human model, related studies have established various mathematical models to simulate human motion. However, the applications were limited to numerical results without intuitive presentations. To overcome this problem, other studies use a skeletal framework to represent the human body, which can visualize the process of simulation and the results of evaluations. However, it lacks a skin surface for the model. Thus, it is somehow different from the real human.

The Taiwan Patent (No. 94132645) entitled “Automated landmark extraction from three-dimensional whole body scanned data” is an invention by the present inventors, having a corresponding patent application in the U.S. Patent and Trademark Office published as U.S. Patent Publication No. 20060171590. This invention is used to define key landmarks from 3D scanned data. But the data outputs are without relationships. Hence, the present invention can be considered as an extension of that invention, which utilizes the data outputs for generating an animatable 3D character.

British Patent No. GB 2389 500 A, entitled “Generating 3D body models from scanned data”, also uses scanned data to establish skin surface for the 3D body models. But the models are static and not animatable. Furthermore, U.S. Pat. No. 6,384,819, entitled “System and method for generating an animatable character”, establishes a customized animatable model with a skeletal framework, but such models are limited to two-dimensional movements.

Thus, to overcome the aforementioned problems of the prior art, it would be an advancement in the art to provide an improved structure that can significantly improve efficacy.

To this end, the inventors have provided the present invention of practicability after deliberate design and evaluation based on years of experience in the production, development and design of related products.

### BRIEF SUMMARY OF THE INVENTION

The present invention mainly uses a 3D scanner to generate the skin surface of a 3D character, with relatively high similarity to a real human. In addition, by controlling the end points of the internal skeleton, the skin surface can be driven for animation. Thus, the static and dynamic attributes of the 3D character can be integrated, so that it can be better applied in related domains such as computer animations and ergonomic evaluations. The appearance can be represented by the smooth skin surface generated by the 3D scanner. The internal skeleton can also be obtained from 3D scanned data. In this way, the locations of body joints and end points of body segments on the internal skeleton can be close to their actual positions, so that the accuracy of motions can be enhanced.

Although the invention has been explained in relation to its preferred embodiment, it is to be understood that many other possible modifications and variations can be made without departing from the spirit and scope of the invention as hereinafter claimed.

### BRIEF DESCRIPTION OF THE SEVERAL VIEWS OF THE DRAWINGS

FIG. 1 shows a schematic view of a composition diagram of the animatable 3D character in the present invention.

FIG. 2 shows a text box diagram of the production method of the animatable 3D character in the present invention.

FIG. 3 shows a schematic view of an illustration of the present invention using scanned data to generate a skin surface.

FIG. 4 shows a cross-sectional view of an illustration of the ranges of control defined by internal and external envelopes of the internal skeleton in the present invention.

### DETAILED DESCRIPTION OF THE INVENTION

The features and the advantages of the present invention will be more readily understood upon a thoughtful deliberation of the following detailed description of a preferred embodiment of the present invention with reference to the accompanying drawings.

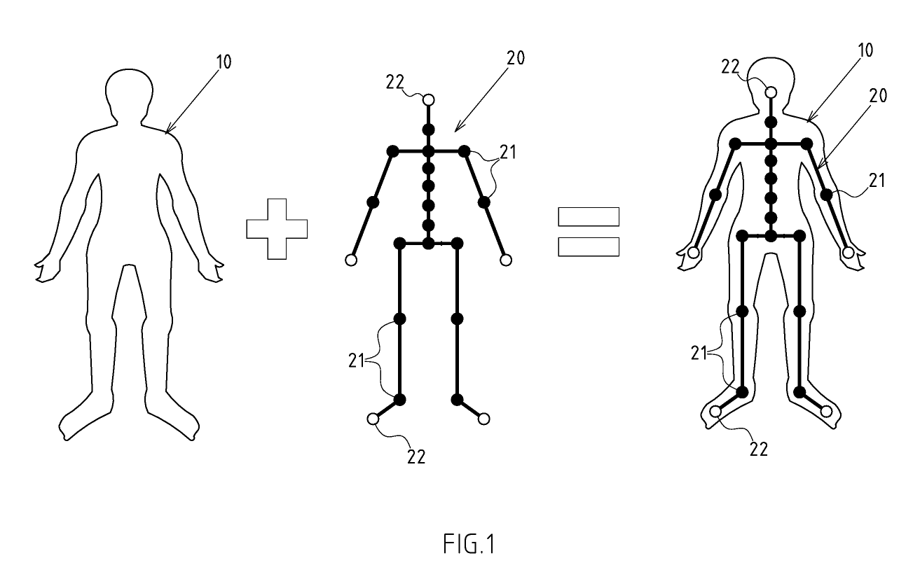

FIG. 1 is a preferred embodiment of the animatable 3D character with a skin surface and an internal skeleton and a production method thereof. This preferred embodiment is provided only for the purpose of explanation. The claim language defines the scope of the present invention.

A skin surface 10 has a preset 3D appearance. The skin surface 10 is not limited to a human appearance. It can also have an animal or a cartoon appearance.

An internal skeleton 20 matches the appearance of the skin surface. The internal skeleton 20 is combined with the skin surface 10.

There is an animation mechanism, so that the skin surface 10 and the internal skeleton 20 can generate interrelated motions.

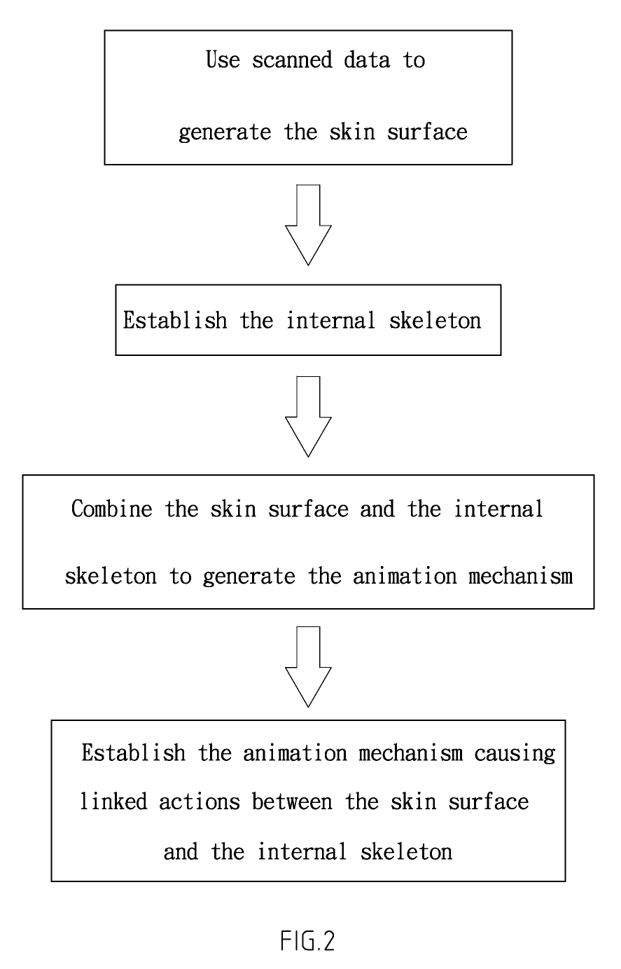

The present invention uses 3D scanned data to generate an animatable 3D character, which is systematically composed of the skin surface 10 and the internal skeleton 20. FIG. 2 shows the implementation steps:
1. Using scanned point data to generate the skin surface;
2. Establishing the internal skeleton; and
3. Combining the skin surface and the internal skeleton to generate the animation mechanism. The steps are individually described as follows.

1. Using Scanned Point Data to Generate the Skin Surface

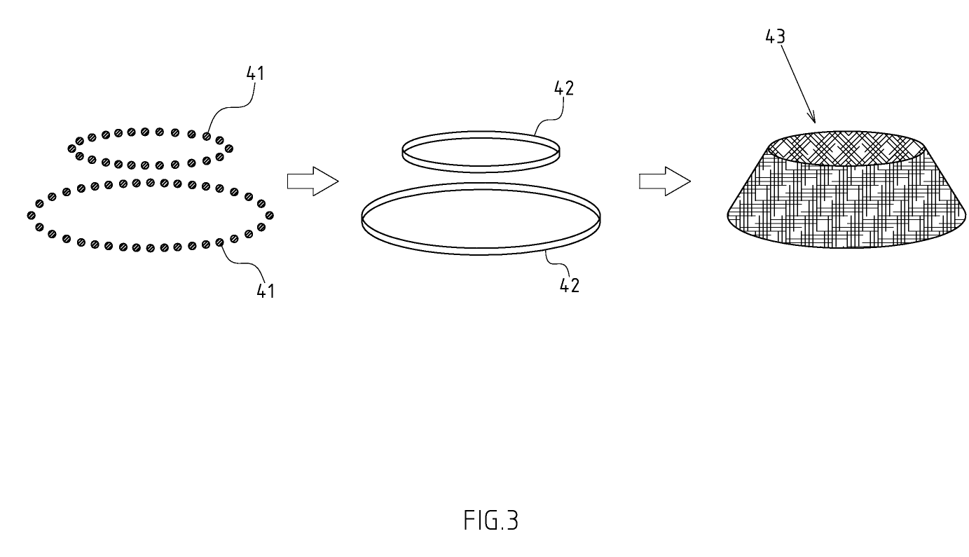

In this stage, the skin surface is mainly generated in a sequence from points to lines and then from lines to a surface. As shown in FIG. 3, first, the 3D scanned data is considered as control points 41 for generating NURBS curves, sequentially linking the control points 41 within the same cross-sectional plane. In this way, an NURBS curve 42 that is close to the body surface can be obtained. Then, using the corresponding relations between the curves, a smooth NURBS surface is created. The appearance model 43 (i.e. skin surface 10) is thus generated.

2. Establishing the Internal Skeleton

Landmark extraction methods such as silhouette analysis, minimum circumference determination, gray-scale detection, human-body contour plots as disclosed by the present inventors in US Patent Publication No. 20060171590, can be used to identify major body joints 21 and the end points of body segments 22 (see FIG. 1) that influence motions. Then, linking these points to form an internal skeleton 20, the method of Inverse Kinematics (IK) is used to control the motions of the 3D character. For example, when the user moves any end point, the related body joints will naturally move to a suitable position based on the constraints defined in the internal skeleton. Then it generates the motions of the 3D character.

3. Combining the Skin Surface 10 and the Internal Skeleton 20 to Generate the Animation Mechanism

After generating the skin surface 10 and the internal skeleton 20 of the 3D character, the last step is to combine them. When the internal skeleton 20 is manipulated, the skin surface 10 can be driven to generate motions. The control points of the skin surface can move along with the corresponding joints of the internal skeleton. Depending on the relative positions and relationships, the degrees of influence on the skin surface by the internal skeleton are different. Hence, it can be used to define the “influence weight” of different joints on the skin surface. Then the motions can be simulated with both the skin surface and the internal skeleton.

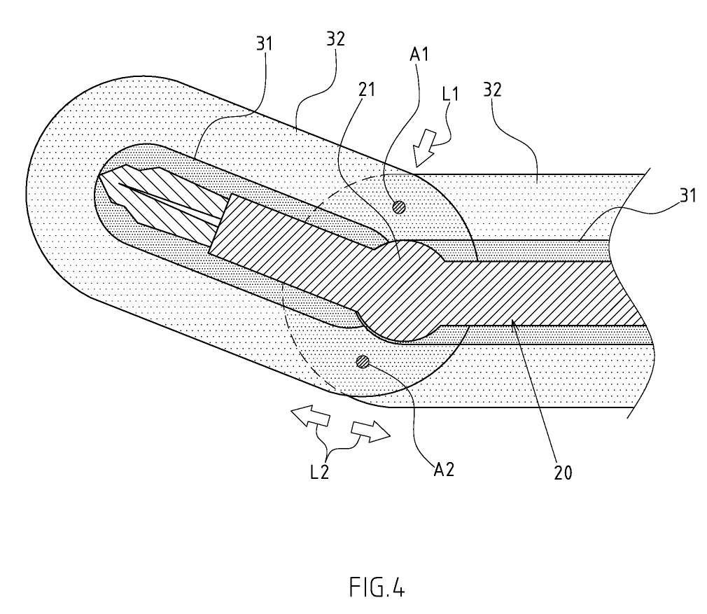

As shown in FIG. 4, the range of control for each section of the internal skeleton 20 can be defined by the internal and external envelopes 31, 32. The skin surface beyond the external envelope 32 is totally not influenced, while the areas within the internal envelope 31 can directly move along with the internal skeleton 20. The area between the internal and external envelopes 31, 32 (see the parts indicated by A1 and A2 in FIG. 4) can be smoothly deformed, so that the changes of muscles can be simulated. Thus, the skin surface 10 can be driven by controlling the internal skeleton 20. As shown in FIG. 4, when the section on the left of the body joint 21 of the internal skeleton 20 has an upward movement, the upper area A1 between the internal and external envelopes 31, 32 that is close to this joint 21 will be loosened (as indicated by the Arrow L1). On the contrary, the lower area A2 between the internal and external envelopes 31, 32 that is close to this joint 21 will be tightened (as indicated by Arrow L2). In this way, the simulation of muscle contraction can be realized to generate motions.

In the end, the method disclosed by the present invention can be integrated into computer animation software, i.e., to simulate various motions with the 3D character generated by using 3D scanned data. By comparing the generated motions and real ones frame by frame, they were found to be very similar. In addition, while comparing the positions of the body joints and the lengths of body segments between both generated and real characters, it is shown that there were very slight but acceptable differences. Therefore, either by subjective or objective methods, it is proven that the present invention is both practical and reliable.

The present invention can be applied in many fields.

1. Hardware and Software Providers of 3D Scanners

By using the 3D scanners, the present invention can extend its applications. It cannot only present an external appearance but also generate an animatable character by controlling of the internal skeleton. Thus, the enhanced functions can attract more users.

2. Product Design

By using the animatable character generated by the present invention, not only the fitness of products can be tested, but also more evaluations can be realized through simulations. For example, combining with virtual garments, not only the flexibility of the garments but also the results of moving with the garments can be tested

3. Work Station Design

For the manufacturing industry, when there is a need to create a new work station, the evaluations can be done in a virtual environment, which may involve the allocations of objects, the man-machine interactions, as well as the arrangement of work flow. Hence, cost and manpower can be greatly reduced.

4. Entertainment Industry

The production of movies, TV programs and electronic games depend more and more on the support of computer animations. By using the present invention to generate an animatable character, the players can closer to the virtual world.

We claim:

1. An animatable three-dimensional (3D) character with a skin surface and an internal skeleton, the 3D character comprising:
a skin surface, having a preset 3D appearance;
an internal skeleton, being associated with said skin surface and being linked to said skin surface; and
an animation mechanism for linked actions between said skin surface and said internal skeleton.

2. The model defined in claim 1, wherein said skin surface is generated by 3D scanned data.

3. The model defined in claim 1, wherein said internal skeleton is generated by scanned data, said internal skeleton having positions identified based on characteristics of body joints and end points of body segments, the points being connected to form said internal skeleton.

4. The model defined in claim 1, wherein said animation mechanism controls different degrees of influence by said internal skeleton on said skin surface, establishing an interrelationship therebetween.

5. The model defined in claim 1, wherein said internal skeleton has sections, each section having a range of control defined by internal and external envelopes, said skin surface beyond the external envelope being totally not influenced, the areas within the internal envelope being directly moveable along with said internal skeleton, and the areas between the internal and external envelopes being deformable and adaptable to movement changes between different sections of said internal skeleton.

6. An animation method for a composite skin surface and an internal skeleton thereof, the method comprising the steps of:
using 3D scanned data to generate a skin surface;
generating an internal skeleton, corresponding to an appearance of said skin surface;
linking said skin surface with said internal skeleton; and
establishing an animation mechanism causing linked actions between said skin surface and said internal skeleton.

7. The method defined in claim 6, further comprising:
forming an appearance of said skin surface based on an interrelationship between curves on said skin surface by data points.

8. The method defined in claim 6, wherein generating said internal skeleton is based on 3D scanned data, said internal skeleton having positions identified based on characteristics of body joints and end points of body segments, the points being connected to form an appearance of said internal skeleton.

9. The method defined in claim 6, further comprising:
controlling different degrees of influence by said internal skeleton on said skin surface to establish an interrelationship therebetween by said animation mechanism.

10. The method defined in claim 6, wherein said internal skeleton has sections, each section having a range of control defined by internal and external envelopes, said skin surface beyond the external envelope being totally not influenced, the areas within the internal envelope being directly moveable along with said internal skeleton, and the areas between the internal and external envelopes being deformable and adaptable to movement changes between different sections of said internal skeleton.
